(19) United States
(12) Patent Application Publication
(10) Pub. No.: US 2013/0243189 A1
(43) Pub. Date: Sep. 19, 2013

(54) METHOD AND APPARATUS FOR PROVIDING INFORMATION AUTHENTICATION FROM EXTERNAL SENSORS TO SECURE ENVIRONMENTS

(71) Applicants: Jan-Erik Ekberg, Vantaa (FI); Mikko Sakari Haikonen, Espoo (FI)

(72) Inventors: Jan-Erik Ekberg, Vantaa (FI); Mikko Sakari Haikonen, Espoo (FI)

(73) Assignee: Nokia Corporation, Espoo (FI)

(21) Appl. No.: 13/423,661

(22) Filed: Mar. 19, 2012

(51) Int. Cl. H04L 9/00

(52) U.S. Cl. 380/44

(57) ABSTRACT

An approach is provided for providing information authentication from external sensors to secure environments. An authentication support platform causes, at least in part, a generation of at least one cryptographic key for use by (a) at least one secure environment, (b) one or more sensors that are associated with at least one device and that are external to the at least one secure environment, or (c) a combination thereof. The authentication support platform further causes, at least in part, an authentication of sensor information transmitted by the one or more sensors to the at least one secure environment based, at least in part, on the cryptographic key.

### BACKGROUND

Service providers and device manufacturers (e.g., wireless, cellular, etc.) are continually challenged to deliver value and convenience to consumers by, for example, providing compelling network services and access to various kinds of information. At the same time, the service providers need to ensure security of information exchanged between the user devices and the provider networks, and also proper use of provided services by the intended users. For example, in services provided based on identity-based schemes such as ticketing services, etc. user authentication as well as information about services used by the users can be areas of concern where unauthorized entities may gain access to service information or users may misrepresent their identity and/or service usage information.

For example, in a ticketing system, if the ticketed user is able to, in the presence of the threat of ticket validation, either stop his travel evidence from being handled by a rating engine, or otherwise modify or misrepresent his travel schedule for his own benefit, such faulty evidence will lead to losses for the transport authority or any entity taking liability for the ticketing system.

Additionally, various data associated with the users and their use of the service that is captured and collected by the service provider, need to be handled in an authenticated manner in the user device (e.g., a mobile device) and through a secure environment binding this information to the provider backend (e.g., a ticketing system) for the benefit of either the user or the service provider, depending on the situation.

### SOME EXAMPLE EMBODIMENTS

Therefore, there is a need for an approach for providing information authentication from external sensors to secure environments.

According to one embodiment, a method comprises causing, at least in part, a generation of at least one cryptographic key for use by (a) at least one secure environment, (b) one or more sensors that are associated with at least one device and that are external to the at least one secure environment, or (c) a combination thereof. The method also comprises causing, at least in part, an authentication of sensor information transmitted by the one or more sensors to the at least one secure environment based, at least in part, on the cryptographic key.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a generation of at least one cryptographic key for use by (a) at least one secure environment, (b) one or more sensors that are associated with at least one device and that are external to the at least one secure environment, or (c) a combination thereof. The apparatus is also caused to cause, at least in part, an authentication of sensor information transmitted by the one or more sensors to the at least one secure environment based, at least in part, on the cryptographic key.

According to another embodiment, a computer-readable storage medium carries one or more sequences of one or more instructions which, when executed by one or more processors, cause, at least in part, an apparatus to cause, at least in part, a generation of at least one cryptographic key for use by (a) at least one secure environment, (b) one or more sensors that are associated with at least one device and that are external to the at least one secure environment, or (c) a combination thereof. The apparatus is also caused to cause, at least in part, an authentication of sensor information transmitted by the one or more sensors to the at least one secure environment based, at least in part, on the cryptographic key.

According to another embodiment, an apparatus comprises means for causing, at least in part, a generation of at least one cryptographic key for use by (a) at least one secure environment, (b) one or more sensors that are associated with at least one device and that are external to the at least one secure environment, or (c) a combination thereof. The apparatus also comprises means for causing, at least in part, an authentication of sensor information transmitted by the one or more sensors to the at least one secure environment based, at least in part, on the cryptographic key.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing information authentication from external sensors to secure environments, according to one embodiment;

FIG. 2 is a diagram of the components of an authentication support platform, according to one embodiment;

FIG. 3 is a flowchart of a process for providing information authentication from external sensors to secure environments, according to one embodiment;

FIG. 4 is a diagram of secure booting of a device, according to one embodiment;

FIG. 5 is a general diagram of a ticket scheme, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for providing information authentication from external sensors to secure environments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

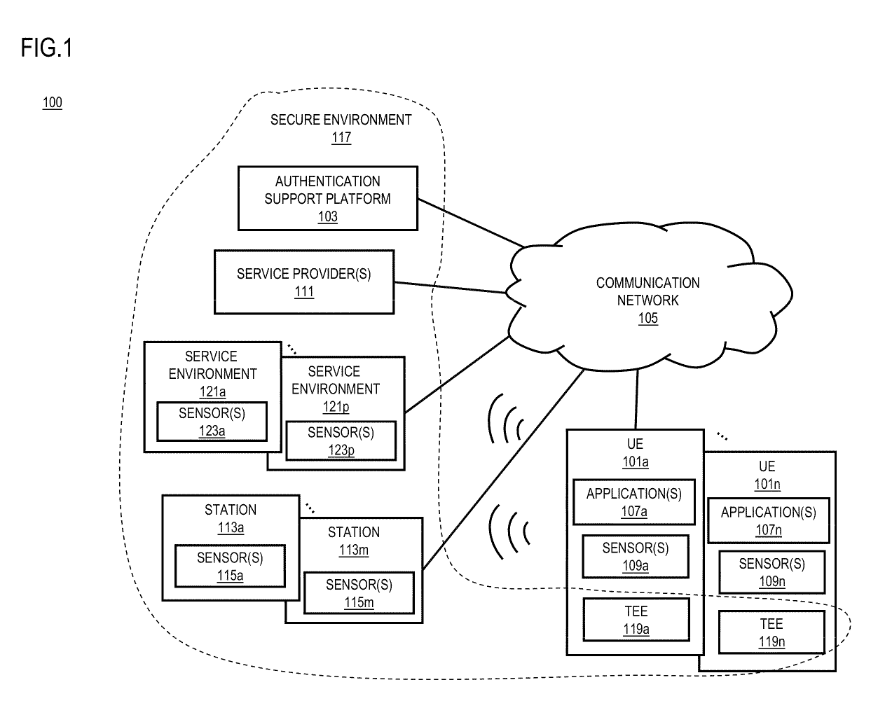

FIG. 1 is a diagram of a system capable of providing information authentication from external sensors to secure environments, according to one embodiment. In one embodiment, in the context of transport ticketing using mobile devices and secure environments therein, such as Embedded Secure Elements, etc., location information is captured in an authenticated manner in the mobile device and through the secure environment.

Traditionally, the transport authorities operate smart-card models for their ticketing process. However, in ticketing systems in which the smart-card model is not used (for example the mobile device is used for user identification), there is a possible risk of losing worth of one or more transportation rides, if the user does not have the actual balance on the backend server hosted account. This can be due to the timing mismatch between validation of the user account and the actual travel time.

Furthermore, some of the currently used public transport electronic tickets represent a form of currency, which is preloaded to a card or phone and consumed at travel time. Other public transport tickets may represent a certificate used, for example, as a monthly pass. This type of tickets will only need identity verification at the time of inspection. There are other server-based solutions, where servers send out unique tokens or tickets that are validated at system entry. For electronic systems, this typically requires real-time backend validation to thwart replay attacks. In the current techniques, ticket verification and auditing is not an issue because either the usage is pre-authorized by the presence of ticket value, or the infrastructure has an online, accurate picture of all needed primitives to trivially weed out fraudulent usage. However, these techniques cannot be used by systems that enable users to pay for transport services as they go without previously charged cards or accounts.

Additionally, in many transportation systems the default charge for a travel is the maximum-length trip, if the user does not remember to check or tap out at the exit station. At times of exceptional activity (e.g., fire in the underground, user pushing a baby-carriage, etc.) some temporary routing at the exit gate can actually make it impossible for the user to appropriately tap out and pay the appropriate fee for the trip taken. Simply forgetting the tapping is also a common occurrence, for example when the user receives a phone call at the same time as he is exiting the station.

It is noted that common interfaces for accessing low-level Global Positioning System (GPS) driver data do not consider authentication as a feature, and this is imperative in order to build reliable systems in open devices for using location (e.g. ticketing protocols) as evidence for billing and charging.

To address the problems described, a system 100 of FIG. 1 introduces the capability to provide information authentication from external sensors to secure environments. In one embodiment, the location information associated with a user of User Equipment (UEs) 101a-101n is securely considered in the provided transport services by the service provider(s) 111 under the supervision of authentication support platform 103. In this embodiment, the location information and the technical mechanisms for ticketing process are combined with other security-relevant algorithms in the UEs 101a-101n.

Typically, embedded/closed GPS devices are used in combination with charging fees at least in prototypes, for example for service environments (e.g., public transport vehicles) 121a-121p passing through taxed areas in cities, and the payment is dependent on factors such as distance travelled by a user of UEs 101a-101n. These are dedicated devices, where the GPS receiver is an integral part of the secure environment, the so called Trusted Computing Base (TCB) of the ticketing system that is composed of components critical of the system's security. Thus the location information from the GPS receiver can be trusted.

In one embodiment, authenticated location information of UEs 101a-101n can be combined into the ticketing system of service provider(s) 111 and managed by a secured environment such as a Trusted Execution Environment (TEE). A TEE 119a-119n is a secure area that resides in the main processor of the UEs 101a-101n and guarantees that sensitive data is stored, processed and protected in a trusted environment. Its ability to offer safe execution of authorized security software, known as trusted applications, enables the TEE 119a-119n to enforce protection, confidentiality, integrity, and access rights of the data belonging to those trusted applications.

In one embodiment, the context information can be securely submitted to the service provider(s) 111 backend (e.g., transportation authority) for processing in combination with ticketing. Since time is a part of the GPS signal, the authenticated information can easily be cross-referenced with timetable data or logs from GPS-enabled vehicles 121a-121p.

In various embodiments, different combined information can help indicate current status of ticketing process. Table 1 shows some examples of determining ticketing status based on the received information.

In one embodiment, authentication features can be added to the typical GPS interfacing protocol, for the TEE 119a-119n in order to insure that the location information it receives is unaltered, for example, in favor of the user for getting cheaper tickets. The combination of location information authenticated to a local TEE 119a-119n, which further carries out a secure, application specific protocol to a service provider infrastructure 111 or other devices makes it possible to reliably add location dependence to protocols also in open devices such as UEs 101a-101n.

TABLE 1

| RECEIVED INFORMATION | TICKETING STATUS |
|---|---|
| Mobile device GPS signal lost | User entered GPS signal unavailable |
| AND subsequent tapping occurred | area AND ticketing is ongoing |
| Ticketing ongoing AND mobile | Possibly, user exit the gate without |
| device GPS signal is lost | tapping |
| Tapping occurred in vehicle AND | user is riding on the vehicle AND |
| mobile device GPS indicates | ticketing is ongoing |
| velocity | |
| Mobile device GPS indicated very | Possibly, user exit vehicle |
| slow movement OR GPS signal | |
| disappears for a period of time | |
| Vehicle GPS and mobile device | User is riding on the vehicle AND |
| GPS signals converged for a | ticketing is ongoing |
| period of time | |

In one embodiment, a transit gate or a station 113a-113m may push the GPS location that the UE 101a-101n has been last seen at, for example before going underground, to a securely stored stack. Additionally, the UE 101a-101n may also store the next GPS location which it receives from the GPS satellite once surfacing to the ground (e.g., after a trip) or from a station 113a-113m at the time of exit. In this embodiment, if the user of UE 101a-101n did not ride or lawfully pay for the trip, the GPS locations (two or more of them, but not current location) are sent by the station 113a-113m to the service provider(s) 111. The GPS location stack values may be registered at the time when the transport application(s) 107a-107n of the UE 101a-101n is registered. Therefore, during deployment, it is assured that the GPS information cannot be sent to any inappropriate parties.

In one embodiment, a service application(s) (e.g. a ticketing application) 107a-107n on UE 101a-101n maintains and stores GPS signal information when plausible relevant from a ticketing perspective. If any incident leads to a ticketing tap being forgotten, or wrong tapping information is exchanged between sensor(s) 109a-109n on UE 101a-101n and sensor(s) 115a-115m on station 113a-113m, the user can decide to submit the GPS log to the service provider(s) (e.g., transport authority) 111 for clearance. This process can be automated. For example, the transport authority authentication module can trust the location information as being collected by the same UE 101a-101n in which the id-resolving for the ticketing takes place (e.g., the UE that taps at the station), and thus, within limits, adjust user travel and especially associated charges, according to the evidence provided by the location information and possible partially collected taps.

In one embodiment, a user authentication inspector at the service environment 121a-121p (e.g., ticket inspector inside a vehicle) may use a Near Field Communication (NFC) enabled UE 101a-101n as an inspection device, in cases where the user either uses an NFC smart card (not shown) as a ticket and/or a UE 101a-101n. Then the GPS coordinates of the inspection event can be combined with user information to either fine the user or determining that the user has rightful access to the vehicle or transportation system. As an example, the ticket inspection in a moving vehicle can be structured as a network-based activity, where, for example, all users with a valid ticket (in the vehicle identified by location and/or ID) can receive a similar, slowly changing picture on their screens to show to an inspector as the inspection activity.

It is noted that the industry standard protocol for communication with GPS receivers is the National Marine Electronics Association (NMEA) 0183 protocol, although inside any given device 101a-101n, proprietary formats may be used. When a GPS fix is made and location information is acquired by the GPS receiver (e.g. sensor 109a-109n), typically the location is indicated by the GPS receiver using a Geographic Position, Latitude/Longitude (GPGLL) and time message, as shown in Table 2.

As seen in Table 2, the information provided by sensor(s) 109a-109n is the proof that is needed for a service provider(s) 111 to evaluate the location of a UE 101a-101n in conjunction with the travel (position and time) with regards to service environment 121a-121p. It is noted that, the GPS receivers do not support message authentication codes by default, which in theory makes it possible for a user to fake the GPS measurement submitted to the TEE 119a-119n by sensor(s) 109a-109n.

TABLE 2
eg1. $GPGLL,3751.65,S,14507.36,E*77
eg2. $GPGLL,4916.45,N,12311.12,W,225444,A

| 4916.46,N Latitude 49 deg. 16.45 min. North | |
|---|---|
| 12311.12,W Longitude 123 deg. 11.12 min. West | |
| 225444 Fix taken at 22:54:44 UTC | |
| A | Data valid |

eg3. $GPGLL,5133.81,N,00042.25,W*75

| | | | |
|---|---|---|---|
| 1 | 2 | 3 | 4 5 |

| | |
|---|---|
| 1 5133.81 | Current latitude |

| 2 N | North/South |
|---|---|
| 3 00042.25 Current longitude | |
| 4 W | East/West |
| 5 *75 | checksum |

$--GLL,lll.ll,a,yyyyy.yy,a,hhmmss.ss,A llll.ll = Latitude of position
a = N or S
yyyyy.yy = Longitude of position
a = E or W
hhmmss.ss = UTC of position
A = status: A = valid data

In one embodiment, where the UE 101a-101n has an internal GPS receiver 109a-109n, during device boot, at the time the integrity of device 101a-101n firmware is cryptographically checked, the TEE 119a-119n may produce a random session key (K), store it in a local memory of UE 101a-101n (not shown), and also submit it to the GPS receiver 109a-109n with a new NMEA command (e.g., Geographical Position and Time Protect key), for example,
“$GPTPK, 19AFF1872B81DA12 . . . 981”
   Additional key management can be constructed if needed, for example if the GPS receiver 109a-109n is not activated at boot and the session key needs to be transported to the GPS receiver at a later stage, when the device Operating System and application(s) 107a-107n have been already running for a while, or if, for example, the GPS receiver is external. Such security overlays do not significantly alter the protocol otherwise.

In one embodiment, the GPS receiver 109a-109n may store the key K for the duration of the boot cycle. Additionally, the GPS receiver may maintain a message counter of submitted location messages (starting from 0). Furthermore, whenever the GPS receiver sends the GPGLL message, it may add the counter value and a cryptographic checksum of the GPGLL position and time information to the message. The checksum which is a fixed-side data computed for the purpose of detecting errors in data, can, for example, be
c=HMAC(k, ctr|message data)
   An example of this augmented message is:

### $GPGLL,4916.45,N,12311.12,W,225444,A,AU,4998,9B6249018CC615A71F761527916257188

where the two added parameters the counter and the checksum, are calculated over the bytes of the message highlighted in bold. The string AU serves as a marker for the fact that the response is authenticated.

In one embodiment, when the GPS receiver message is given to the TEE 119a-119n, the TEE can deduce the authenticity of the location data (since it is constructed with a key shared only between the TEE 119a-119n and the GPS receiver 109a-109n). The GPS receiver data need not be universally authenticable (this may be even a privacy risk), however, it provides the assurance that the information is not tampered with inside the UE 101a-101n as it moves from the GPS receiver 109a-109n through Operating System drivers into the TEE 119a-119n.

In one embodiment, a ticketing application(s) 107a-107n inside the TEE 119a-119n can use the location data as a part of an evidence package for an external service provider(s) 111 to prove the physical location of the user. It is noted that the combination of building trustworthy location information inside the device 101a-101n for remote attestation (proving) is not uniquely limited to ticketing, but can be used for a variety of purposes and protocols.

In one embodiment, a partially off-line solution is used that is certificate and signature based and intended for pay-as-you-go travel for a user of UE 101a-101n with no restriction on monthly or annual usage. In this embodiment, a counter and a signature key are used in the secure environment 117, as a fundamental security primitive, and every time a signature is requested from the environment by any entity outside the secure environment 117 (e.g., by a UE 101a-101n) the counter is included in the signature (bound to the signature). Furthermore, the counter is automatically updated at every signature event.

In one embodiment, the control and auditing mechanisms by the authentication support platform 103 is enforced locally at the UE 101a-101n by the operation of the TEE 119a-119n. In this embodiment, a ticketing license is associated with each UE 101a-101n which may include a maximum number of ticketing taps that a UE 101a-101n is allowed to perform until a release commitment is given from a service provider(s) 111 to the TEE 119a-119n. This system can force the UE 101a-101n to report ticketing taps to the service provider(s) 111, to the authentication support platform 103, or a combination thereof.

In one embodiment, the tapping limit may also include an aspect of user ticketing history. For example, a UE 101a-101n that has performed successfully in the past may be assigned with a higher tap limit than a new user or a user/device with a record of fraudulent use.

In one embodiment, an internal authenticated channel from a local positioning entity may be used in a UE 101a-101n. The positioning entity can be a GPS, a WLAN device with similar features, a server-assisted location system by which the UE 101a-101n location is determined by a combination of local, network and peer-to-peer context, or a combination thereof. Ii is important to note that in all of these scenarios, the location information of UE 101a-101n includes authentication information, resolvable by the TEE 119a-119n, to protect against ticketing fraud. The local TEE 119a-119n operation may also temporarily be unavailable based on context such as time. For example, a UE 101a-101n may be restricted to no more than one taps in every 5 minutes, or only one tap from the same station 113a-113m, or from within the service environment 121a-121p (e.g., inside a bus, train, etc.). These restrictions provide prevention measures for local man-in-the middle fraud by co-riders.

In one embodiment, the authentication support platform 103 enforces terminal authentication. For example, identity verification may be performed only among counterpart UEs 101a-101n that are all part of the same ticketing system provided by the service provider(s) 111. The authentication support platform 103 can cryptographically verify whether a UE 101a-101n belong to a system provided by a service provider(s) 111.

In one embodiment, the control and auditing mechanisms via the authentication support platform 103 is performed at the service provider(s) 111. For example, the service provider(s) 111 may be part of a computation cloud (not shown) and a posteriori auditing in the service provider cloud can uniquely identify misbehaving users or UEs 101a-101n. In this embodiment, the TEEs 119a-119n, any TEEs at the stations 113a-113m (not shown), TEEs at the service environments 121a-121p (not shown) use counters for all their cryptographic operations. The counters can be used to construct a strict ordering of events conducted by TEEs 119a-119n, TEEs on stations 113a-113m, TEEs at service environments 121a-121p, or a combination thereof.

In one embodiment, the authentication support platform 103 can use the set of ordered event constructed by counters to construct a mapping of events that occurred during the course of travel by a UE 101a-101n. Since the service provider(s) 111 cloud can log the time the event reports were received, an approximate time interval (e.g. a start and an end) can be attached to each event occurrence. Furthermore, taps at stations 113a-113m can add location information to each event and ticket inspectors on board the service environments 121a-121p add additional, accurately timed events, to the mapping.

In one embodiment, various information can be deduced from the events mapping constructed by the authentication support platform 103. For example, the mapping can be used to answer questions such as, is the mapping for each UE 101a-101n consistent? (do all counter values exist, and are the taps consistent with entry and exit locations?), Are all taps at stations 113a-113m accounted for (over the set of UEs 101a-101n who used the station 113a-113m), Combined with verification, is the counter of the entry tap at station 113a-113m for a UE 101a-101n consistent with the time of availability of the service environment 121a-121p at the station (vehicle arrival at the station)? (If not, the user of UE 101a-101n may have used a relay tapper as soon as he had seen the inspector.)

In one embodiment, the authentication support platform 103 may have a back channel. For example, a station 113a-113m may log all taps by UEs 101a-101n and feed the information about those (already occurred) taps to the authentication support platform 103 together with subsequent taps by other UEs 101a-101n. This is a way to improve information feedback to the authentication support platform 103 in cases where one or more UEs 101a-101n intentionally, or due to some malfunction, are not able to report back evidence.

As shown in FIG. 1, the system 100 comprises a set of user equipments (UEs) 101a-101n having connectivity to an authentication support platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101a-101n is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101a-101n can support any type of interface to the user (such as “wearable” circuitry, etc.).

By way of example, the UEs 101a-101n, and the authentication support platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

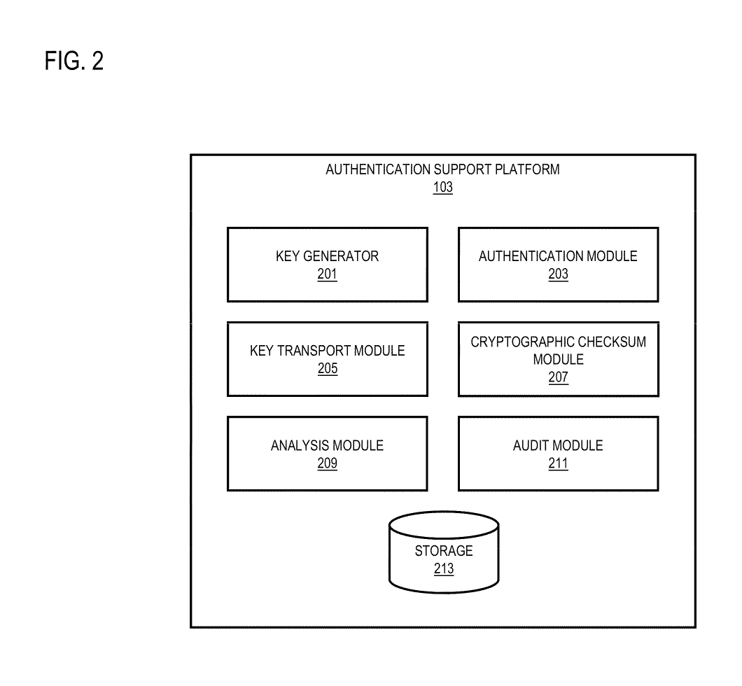

FIG. 2 is a diagram of the components of and authentication support platform, according to one embodiment. By way of example, the authentication support platform 103 includes one or more components for providing information authentication from external sensors to secure environments. It is contemplated that the functions of these components may be combined in one or more components or performed by other components of equivalent functionality. In this embodiment, the authentication support platform 103 includes a key generator 201, an authentication module 203, a key transport module 205, a checksum module 207, an analysis module 209, an audit module 211 and a storage 213.

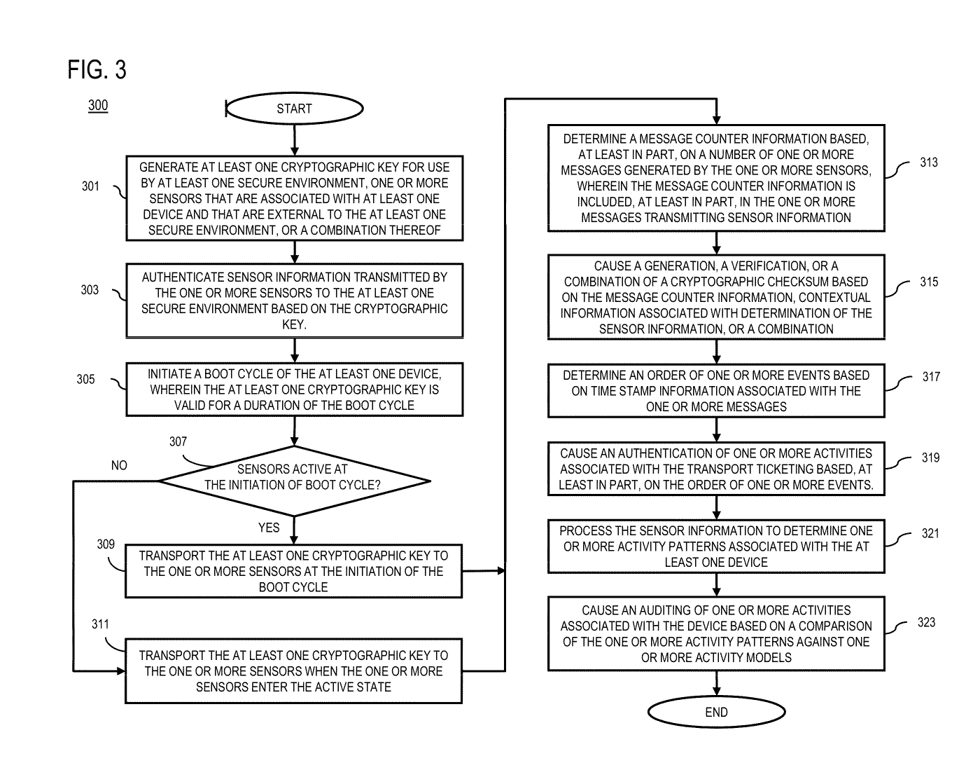

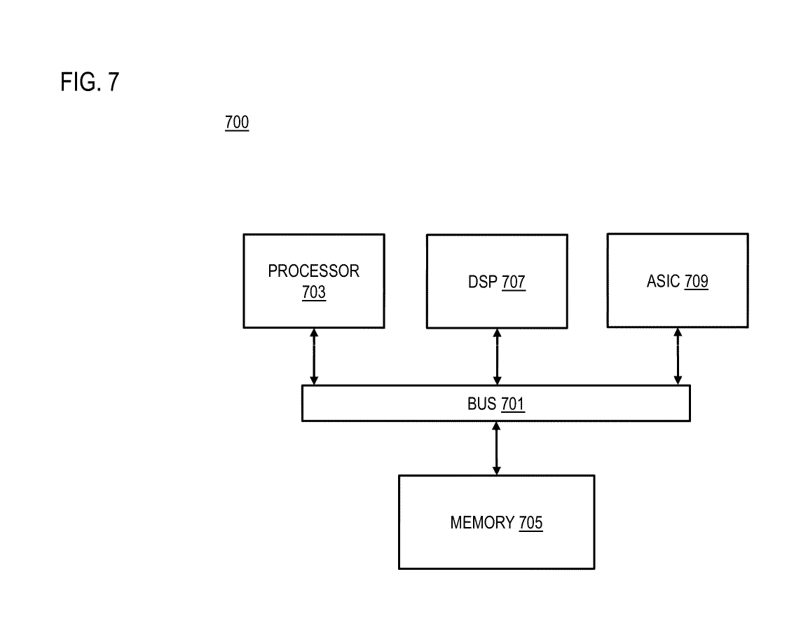

FIG. 2 is described with reference to FIG. 3, wherein FIG. 3 is a flowchart of a process for providing information authentication from external sensors to secure environments, according to one embodiment. In one embodiment, the authentication support platform 103 performs the process 300 and is implemented in, for instance, a chip set including a processor and a memory as shown in FIG. 7.

In one embodiment, per step 301 of flow chart 300, the key generator 201 causes, at least in part, a generation of at least one cryptographic key. The cryptographic key can be used by at least one secure environment 117 and any entities included in the secure environment 117 such as, for example, TEE 119a-119n, station 113a-113m, sensor(s) 115a-115m, sensor(s) 123a-123p etc. Additionally, the cryptographic key can be also used by one or more sensor(s) 109a-109n that are associated with at least one UE 101a-101n and are external to the at least one secure environment 117. The generated cryptographic key may be stored in storage 213.

In one embodiment, the one or more sensor(s) 109a-109n may consist, at least in part, one or more location sensors including one or more satellite location receiver; and the at least one cryptographic key may be transported to the one or more sensor(s) 109a-109n via one or more commands of a sensor communication protocol such as, for example, National Marine Electronics Association (NMEA) 0183 protocol.

In one embodiment, per step 303 of flow chart 300, the authentication module 203 causes, at least in part, an authentication of sensor information from sensor(s) 109a-109n transmitted by the one or more sensor(s) 109a-109n to the at least one secure environment 117 based, at least in part, on the cryptographic key.

In one embodiment, per step 305 of flowchart 300, the key transport module 205 determines an initiation of a boot cycle of the at least one UE 101a-101n, wherein the at least one cryptographic key is valid for a duration of the boot cycle.

In one embodiment, per step 307 of flowchart 300, the key transport module 205 determines whether the one or more sensor(s) 109a-109n are in an active state at the initiation of the boot cycle. If the one or more sensor(s) 109a-109n are in the active state, per step 309 the key transport module 205 causes, at least in part, a transport of the at least one cryptographic key to the one or more sensor(s) 109a-109n at the initiation of the boot cycle. Otherwise, if the one or more sensor(s) 109a-109n are not in the active state, per step 311, the key transport module 205 causes, at least in part, a transport of the at least one cryptographic key to the one or more sensor(s) 109a-109n when the one or more sensors enter the active state if the one or more sensors are not in the active state. The key transport module 205 may cause the transport of the cryptographic key to the sensor(s) 109a-109n directly by the authentication support platform 103, via the communication network 105, via other components of the secure environment 117 such as the service environment 121a-121p and stations 113a-113m, or a combination thereof.

In one embodiment, the authentication support platform 103 receives one or more messages, wherein the one or more messages include sensor information associated with sensor(s) 109a-109n and have been transmitted from the sensor(s) 109a-109n to the at least one secure environment 117. In this embodiment, per step 313 of flowchart 300, the checksum module 207 causes, at least in part, a determination of a message counter information based, at least in part, on a number of the one or more messages generated by the one or more sensor(s) 109a-109n, wherein the message counter information is included, at least in part, in the one or more messages. The counter information may be recorded locally at a local memory of the UE 101a-101n and included in the message before the message is sent to the secure environment 117. Subsequently, the authentication support platform 103 and the service provider(s) 111 may process the sensor information for transport ticketing.

In one embodiment, per step 315 of flowchart 300, the checksum counter 207 causes, at least in part, a generation, a verification, or a combination thereof of a cryptographic checksum based, at least in part, on the message counter information, contextual information associated with determination of the sensor information, or a combination thereof. The cryptographic checksum can be generated based on various available data such as, for example, received sensor information form sensor(s) 109a-109n, history of sensor information from UE 101a-101n, types and levels of services provided to UE 101a-101n by the service provider(s) 111, tapping data (events) associated with UEs 101a-101n collected at the stations 113a-113m (sensor(s) 115a-115m) or at service environments 121a-121p (sensor(s) 123a-123p), or a combination thereof.

In one embodiment, per step 317 of flowchart 300, the analysis module 209 determines an order of one or more events, as stated, based, at least in part, on time stamp information associated with the one or more messages from the sensor(s) 109a-109n. The order shows the sequence of the events and reveals fraudulent activities that may be out of sequence. For example, if the time UE 101a-101n was tapped at station 113a-113m occurs after a vehicle 121a-121n left the station, and the GPS information of UE 101a-101n indicates that the UE is aboard the vehicle, the analysis module 209 can conclude from the sequence of these events that an error may have occurred with regards to the UE 101a-101n.

In one embodiment, per step 319 of flowchart 300, the authentication module 203 causes, at least in part, an authentication of one or more activities associated with the transport ticketing based, at least in part, on the order of one or more events and the analysis by the analysis module 209. The authentication may include further analysis for determining the source of the discrepancy in the event order.

In one embodiment, per step 321 of flowchart 300, the analysis module 209 processes and/or facilitates a processing of the sensor information from sensor(s) 109a-109n to determine one or more activity patterns associated with the at least one UE 101a-101n. The activity pattern can be stored in storage 213 as part of the history of the activities of UE 101a-101n. The history can be used by the authentication support platform 103 for determining privileges of UE 101a-101n when providing services to UE 101a-101n (e.g., allowed number of tapping).

In one embodiment, per step 323 of flowchart 300, the audit module 211 causes, at least in part, an auditing of one or more activities associated with the UE 101a-101n based, at least in part, on a comparison of the one or more activity patterns determined by the analysis module 209 against one or more activity models. The activity models may be predetermined models developed by service provider(s) 111 and stored in storage 213, at service provider(s) 111, or a combination thereof.

In one embodiment, the one or more activity patterns, the one or more activities, the one or more activity models, or a combination thereof relate, at least in part, to transport ticketing using one or more proximity means including, at least in part, near field communications, short range wireless, or a combination thereof.

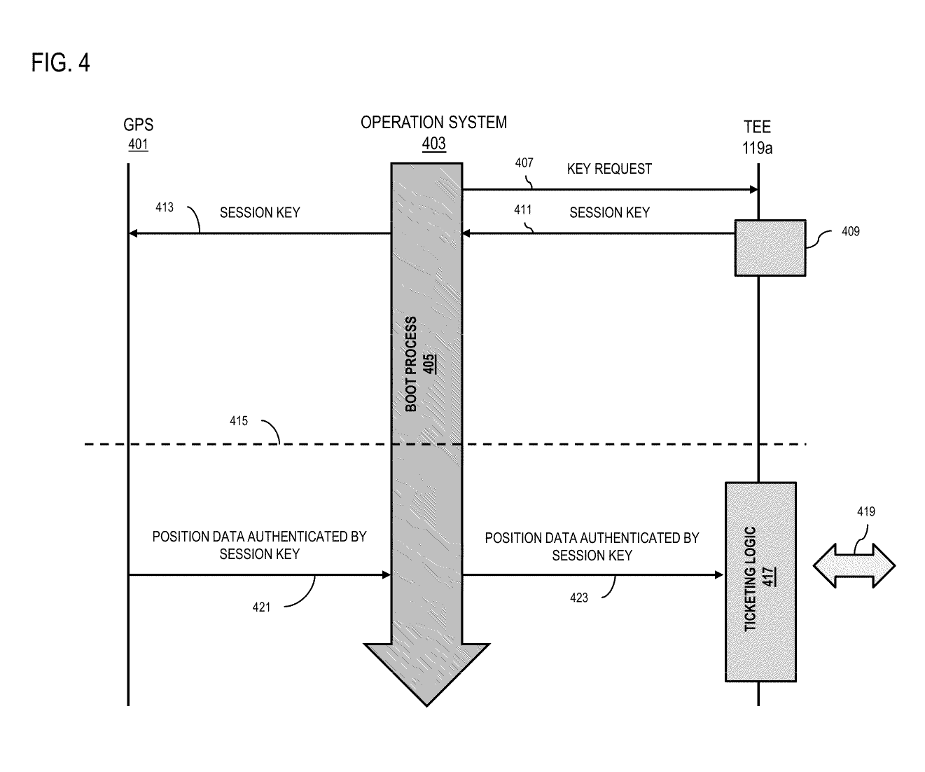

FIG. 4 is a diagram of secure booting of a device, according to one embodiment. FIG. 4 shows a communication between a GPS 401 associated with a UE 101a-101n, the GPS can be a combination of hardware and firmware, an operation system (OS) 403 of UE 101a-101n with a secure boot capability, and a TEE 119a of a UE 101a (not shown).

In one embodiment, arrow 405 represents a boot process, at the start of which, the OS 403 request a key from TEE 119a (shown by arrow 407). Upon receiving the key request 407, the TEE 119a executes a ticketing algorithm 409 that leads to the generation of a session key by the authentication support platform 103 as described with regards to FIGS. 2 and 3.

In one embodiment, the authentication support platform 103 sends the generated session key to TEE 119a. The session key is then transmitted from TEE 119a to the OS 403 and the GPS 401 as shown by arrows 411 and 413.

In one embodiment, the booting process of UE 101a-101n is completed at the point shown by the dotted line 415. At this point the UE 101a-101n has booted into its normal run state. However, from this point on there is a possibility that the OS 403 is attacked by viruses or due to user actions. For example, the user may attack the OS 403 to change position data, to circumvent the payment models for the ticketing (e.g. pretend to take trips shorter than the actual trips).

In one embodiment, the position data provided by the GPS 401 accompanied by the session key is sent from the GPS 401 to the OS 403 (arrow 421). The OS 403 then sends the position data and the session key to the TEE 119a (arrow 423). In this embodiment, the TEE 119a is equipped with the ticketing logic 417 which enables the TEE 119a to validate the position data based on the session key, under the supervision of the authentication support platform 103. At this point, if a user or OS 403 changes the position data received from the GPS 401, at the gap between arrows 421 and 423, the validation process by the TEE 119a will fail.

In one embodiment, the validation process may be performed by the authentication support platform 103 and the TEE 119a may function as a secure interface between the UE 101a-101n and the authentication support platform 103.

In one embodiment, if the position data validation by the TEE 119a is performed successfully, the position data is transmitted from the TEE 119a via Near Field Communication (NFC) tags associated to the UE 101a-101n to the station 113a-113m, to the service environment 121a-121p, or a combination thereof. In other embodiments, the position data may be directly transferred from the TEE 119a to the authentication support platform 103, to the service provider(s) 111, or a combination thereof, via the communication network 105. The data transfer is shown by arrow 419.

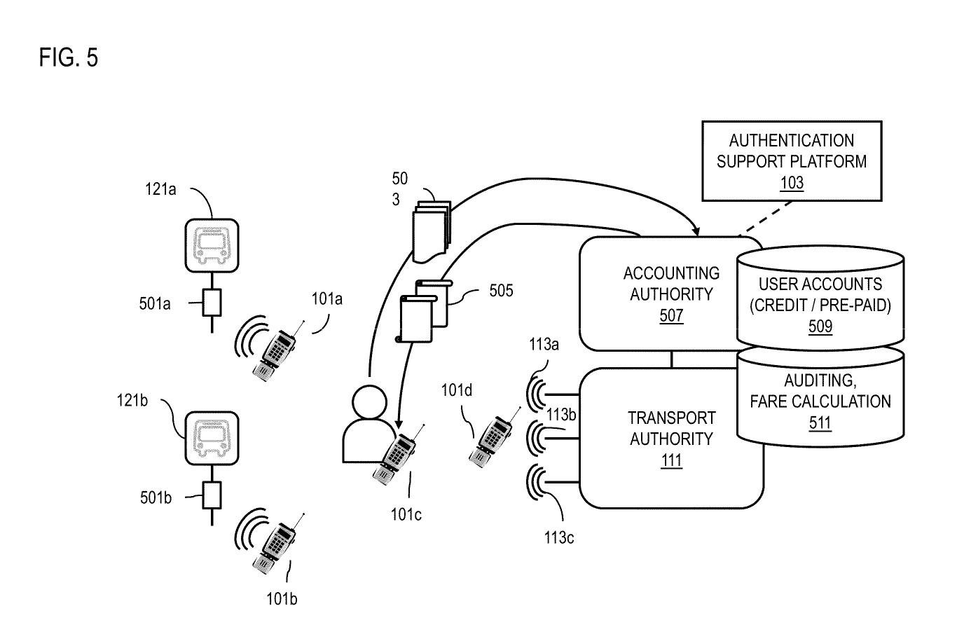

FIG. 5 is a general diagram of a ticket scheme, according to one embodiment. In one embodiment, the transport authority system (the service provider(s) 111) operates the vehicles (service environments) 121a and 121b and also provides an integrated network for its non-gated ticket readers 501a and 501b onboard the vehicles 121a and 121b. The gated NFC readers 113a, 113b, and 113c are assumed to be connected to a backend system of transport authority 111 and the authentication support platform 103. Therefore, the readers 113a-113c can receive information such as certificate revocation lists (CRLs) which they refer to during user verification.

In one embodiment, all the information exchanged during such verification is collected as transaction evidence and forwarded to a backend processing unit, such as a an accounting system 507, a fare calculation engine 511, or a combination thereof. The fare calculation engine 511 may be a database maintained by the transport authority 111.

In one embodiment, the transport authority 111 is responsible for distributing and maintaining the terminals 501a and 501b (e.g., smart cards) for non-gated travel. These smart cards are physically and firmly attached to their location and are tamper-resistant.

In one embodiment, the accounting authority 507 is responsible for fare collection from the users of UEs 101a-101d. A transport authority 111 can simultaneously be connected to several accounting authorities 507. Additionally, all users may have a relationship with at least one accounting authority 507, in the form of a prepaid or credit-based user account 509. In one embodiment, users account status can be used for determining user history that can affect the services provided to the user.

In one embodiment, the accounting authority 507 is also responsible for generating ticketing credentials and provisioning secrets to the TEE 119a-119d (not shown) in UEs 101a-101d. Furthermore, the accounting authority 507 may be responsible for the cryptographic validation of transport evidence and user back-listing (e.g. for users with poor history).

The processes described herein for providing information authentication from external sensors to secure environments may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

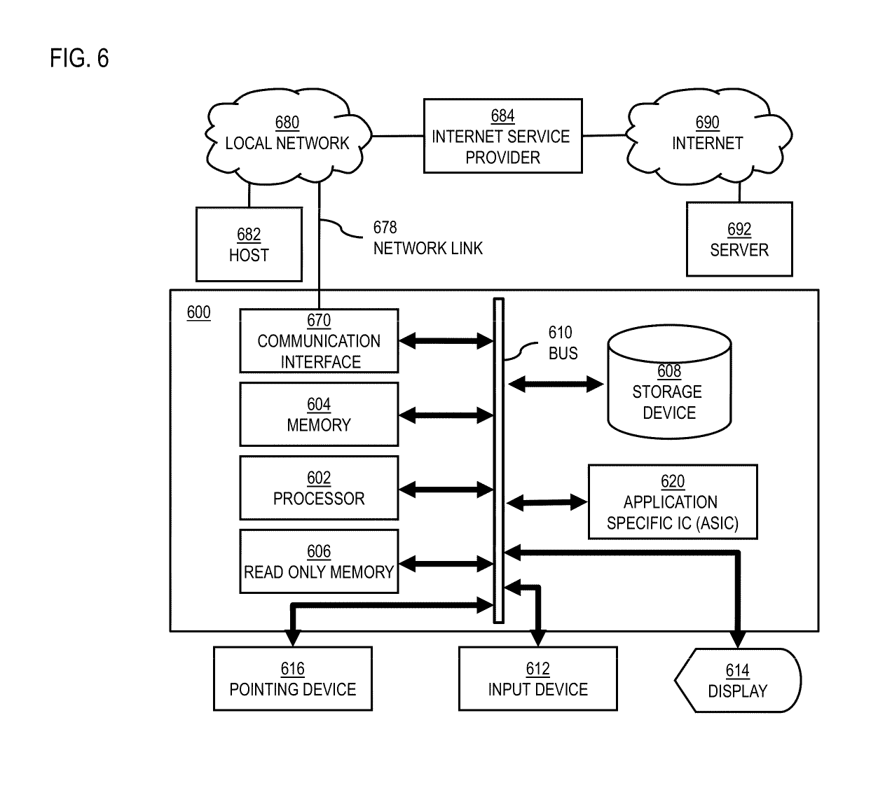

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide information authentication from external sensors to secure environments as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing information authentication from external sensors to secure environments.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to provide information authentication from external sensors to secure environments. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing information authentication from external sensors to secure environments. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing information authentication from external sensors to secure environments, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing information authentication from external sensors to secure environments, to the UEs 101a-101n.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide information authentication from external sensors to secure environments as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing information authentication from external sensors to secure environments.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real-time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide information authentication from external sensors to secure environments. The memory 705 also stores the data associated with or generated by the execution of the inventive steps.

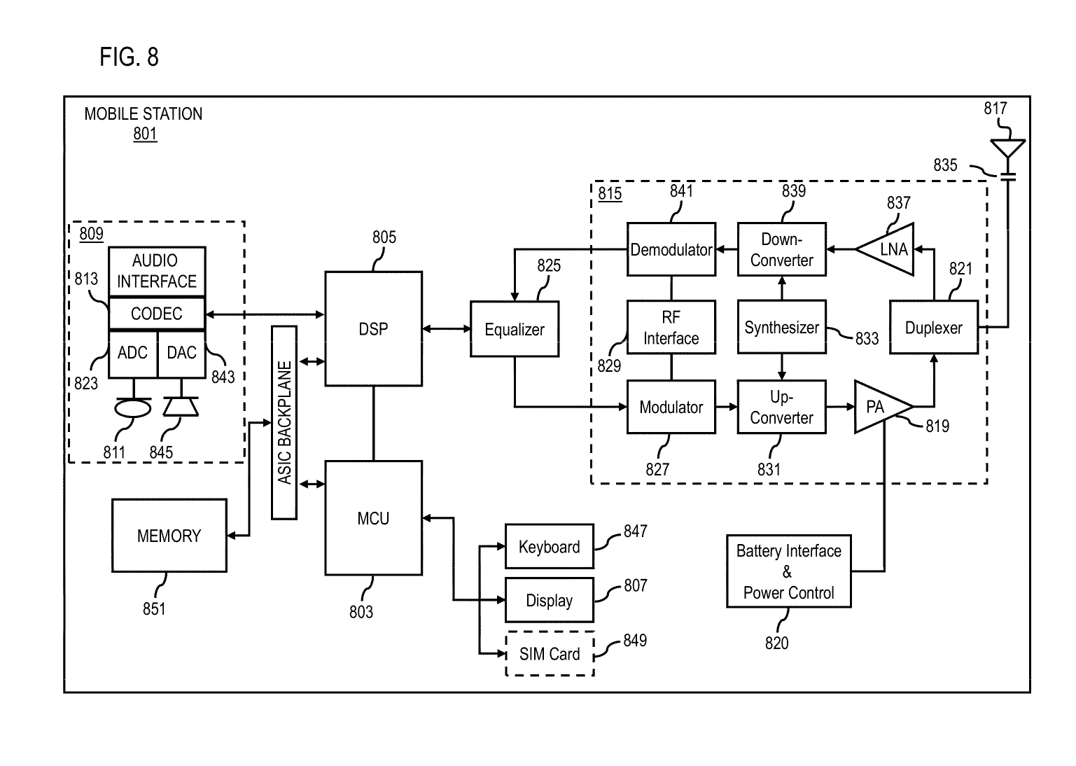

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing information authentication from external sensors to secure environments. Generally, a radio receiver is often defined in terms of front-end and backend characteristics. The front-end of the receiver encompasses all of the Radio Frequency (RF) circuitry whereas the backend encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing information authentication from external sensors to secure environments. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide information authentication from external sensors to secure environments. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a generation of at least one cryptographic key for use by (a) at least one secure environment, (b) one or more sensors that are associated with at least one device and that are external to the at least one secure environment, or (c) a combination thereof; and
an authentication of sensor information transmitted by the one or more sensors to the at least one secure environment based, at least in part, on the cryptographic key.

2. A method of claim 1, wherein the (1) data and/or (2) information and/or (3) at least one signal are further based, at least in part, on the following:
an initiation of a boot cycle of the at least one device,
wherein the at least one cryptographic key is valid for a duration of the boot cycle.

3. A method of claim 2, wherein the (1) data and/or (2) information and/or (3) at least one signal are further based, at least in part, on the following:
at least one determination of whether the one or more sensors are in an active state at the initiation of the boot cycle; and
a transport of the at least one cryptographic key to the one or more sensors (a) at the initiation of the boot cycle if the one or more sensors are in the active state, or (b) when the one or more sensors enter the active state if the one or more sensors are not in the active state.

4. A method of claim 1, wherein the sensor information is transmitted to the at least one secure environment as one or more messages, wherein the (1) data and/or (2) information and/or (3) at least one signal are further based, at least in part, on the following:
at least one determination of a message counter information based, at least in part, on a number of the one or more messages generated by the one or more sensors,
wherein the message counter information is included, at least in part, in the one or more messages.

5. A method of claim 4, wherein the (1) data and/or (2) information and/or (3) at least one signal are further based, at least in part, on the following:
a generation, a verification, or a combination thereof of a cryptographic checksum based, at least in part, on the message counter information, contextual information associated with determination of the sensor information, or a combination thereof.

6. A method of claim 4, wherein the at least one secure environment processes and/or facilitates a processing of the sensor information for transport ticketing.

7. A method of claim 6, wherein the (1) data and/or (2) information and/or (3) at least one signal are further based, at least in part, on the following:
at least one determination of an order of one or more events based, at least in part, on time stamp information associated with the one or more messages; and
an authentication of one or more activities associated with the transport ticketing based, at least in part, on the order of one or more events.

8. A method of claim 1, wherein the (1) data and/or (2) information and/or (3) at least one signal are further based, at least in part, on the following:
a processing of the sensor information to determine one or more activity patterns associated with the at least one device; and
an auditing of one or more activities associated with the device based, at least in part, on a comparison of the one or more activity patterns against one or more activity models.

9. A method of claim 8, wherein the one or more activity patterns, the one or more activities, the one or more activity models, or a combination thereof relate, at least in part, to transport ticketing using one or more proximity means including, at least in part, near field communications, short range wireless, or a combination thereof.

10. A method of claim 1, wherein the one or more sensors consists, at least in part, one or more location sensors including one or more satellite location receiver; and wherein the at least one cryptographic key is transported to the one or more sensors via one or more commands of a sensor communication protocol.

11. An apparatus comprising:
at least one processor; and
at least one memory including computer program code for one or more programs,
the at least one memory and the computer program code configured to, with the at least one processor, cause the apparatus to perform at least the following,
cause, at least in part, a generation of at least one cryptographic key for use by (a) at least one secure environment, (b) one or more sensors that are associated with at least one device and that are external to the at least one secure environment, or (c) a combination thereof; and
cause, at least in part, an authentication of sensor information transmitted by the one or more sensors to the at least one secure environment based, at least in part, on the cryptographic key.

12. An apparatus of claim 11, wherein the apparatus is further caused to:
determine an initiation of a boot cycle of the at least one device,
wherein the at least one cryptographic key is valid for a duration of the boot cycle.

13. An apparatus of claim 12, wherein the apparatus is further caused to:
determine whether the one or more sensors are in an active state at the initiation of the boot cycle; and
cause, at least in part, a transport of the at least one cryptographic key to the one or more sensors (a) at the initiation of the boot cycle if the one or more sensors are in the active state, or (b) when the one or more sensors enter the active state if the one or more sensors are not in the active state.

14. An apparatus of claim 11, wherein the sensor information is transmitted to the at least one secure environment as one or more messages, the apparatus further caused to:
cause, at least in part, a determination of a message counter information based, at least in part, on a number of the one or more messages generated by the one or more sensors,
wherein the message counter information is included, at least in part, in the one or more messages.

15. An apparatus of claim 14, wherein the apparatus is further caused to:
cause, at least in part, a generation, a verification, or a combination thereof of a cryptographic checksum based, at least in part, on the message counter information, contextual information associated with determination of the sensor information, or a combination thereof.

16. An apparatus of claim 14, wherein the at least one secure environment processes and/or facilitates a processing of the sensor information for transport ticketing.

17. An apparatus of claim 16, wherein the apparatus is further caused to:
determine an order of one or more events based, at least in part, on time stamp information associated with the one or more messages; and
cause, at least in part, an authentication of one or more activities associated with the transport ticketing based, at least in part, on the order of one or more events.

18. An apparatus of claim 11, wherein the apparatus is further caused to:
process and/or facilitate a processing of the sensor information to determine one or more activity patterns associated with the at least one device; and
cause, at least in part, an auditing of one or more activities associated with the device based, at least in part, on a comparison of the one or more activity patterns against one or more activity models.

19. An apparatus of claim 18, wherein the one or more activity patterns, the one or more activities, the one or more activity models, or a combination thereof relate, at least in part, to transport ticketing using one or more proximity means including, at least in part, near field communications, short range wireless, or a combination thereof.

20. An apparatus of claim 11, wherein the one or more sensors consists, at least in part, one or more location sensors including one or more satellite location receiver; and wherein the at least one cryptographic key is transported to the one or more sensors via one or more commands of a sensor communication protocol.

21-48. (canceled)
